(19) United States
(12) Patent Application Publication
(10) Pub. No.: US 2009/0053673 A1
(43) Pub. Date: Feb. 26, 2009

(54) METHOD FOR LOCALIZED TREATMENT OF PERIODONTAL TISSUE

(75) Inventors: Ralf Klabunde, Winterthur (CH); Patrik Luscher, Pfaffikon (CH)

Correspondence Address: WOOD, HERRON & EVANS, LLP (ZIMMER), 2700 CAREW TOWER, 441 VINE STREET, CINCINNATI, OH, 45202, US

(73) Assignee: ZIMMER, INC., Warsaw, IN (US)

(21) Appl. No.: 11/844,139

(22) Filed: Aug. 23, 2007

(51) Int. Cl. A61C 8/00; A61C 3/00

(52) U.S. Cl. 433/90; 433/173

(57) ABSTRACT

A method for localized treatment using a microneedle array to controllably administer a dose of a bone anabolic drug localized at a dental implant site. The bone anabolic drug enhances alveolar bone growth at the dental implant site. Examples of drugs that may be used include, but are not limited to, bone anabolic drugs (e.g., bone morphogenetic proteins, fibroblast growth factor 2, statins parathyroid hormone), and/or drugs that target cell signalling pathways involved in the regulation of the osteoblastic lineage and function. In one embodiment, the method includes monitoring the dental implant site for periodontal tissue generation sufficient to support a dental implant. When sufficient tissue is generated, the dental implant is surgically inserted in the dental implant site. Additional doses of the bone anabolic drug may be delivered prior to detecting tissue generation.

### TECHNICAL FIELD

Methods for controlled localized drug delivery by a microneedle array to a periodontium.

### BACKGROUND

Common causes of tooth loss are due to injury or to diseases such as gingivitis, pyorrhea, or periodontitis. For example, periodontitis destroys tooth-supporting tissues and, if left untreated, leads to tooth loss. Besides cosmetic concerns, tooth loss promotes atrophy of alveolar bone that provides structural support for teeth. Loss of alveolar bone reduces the probability of successful tooth replacement.

One type of tooth replacement surgically installs one or more dental implants at the location of the lost tooth. Examples of dental implants include root form, blade form, and subperiosteal implants, etc. Dental implants require a sufficient quantity and quality of bone for successful attachment. Therefore, an individual with severe atrophy who needs a dental implant may not have sufficient bone with which to support the implant.

Treatments to reverse or overcome atrophy of the alveolar bone are limited.

Some treatments reduce bone atrophy by treating the site following tooth loss. For example, packing an extraction site with bone graft material may reduce alveolar bone loss. Immediate placement of a dental implant into the extraction site may also allow successful dental implantation. However, each of these treatments is effective only during a period shortly after tooth removal.

Other less contemporaneous treatments may include invasive surgical treatment of the alveolar bone. During a surgical procedure, a scaffold designed to promote growth of the alveolar bone and supporting tissues is placed into or onto the alveolar bone. Various types of scaffolds may be inserted into or in close proximity to the alveolar ridge prior to implantation of a dental implant.

Scaffolds may incorporate bioactive molecules to enhance tissue growth, but such scaffolds have a number of drawbacks. As one example, the scaffold's holding capacity for the bioactive molecules is limited, so that treatment duration is equally limited and may last only for a few days to about a week. Treatment duration is thus determined by the scaffold's holding capacity and release rate of the bioactive molecules. The release rate depends on many factors that are difficult to control. Examples include the rate at which the scaffold degrades, the size of the pores in the scaffold, the type of bioactive molecule incorporated, and the biochemical constituents present at the dental implant site. It is therefore difficult to control or even predict the release rate from the scaffold with any degree of confidence, particularly over a prolonged period. Once the scaffold is depleted of the bioactive molecules, additional scaffolds must be surgically implanted for continued treatment. Consequently, treatments utilizing scaffolds have had only limited success.

Current corrective procedures are costly, painful, time consuming, and technically sensitive in that the practitioner's skills inserting a dental implant are directly related its degree of success. Generally, as the quantity and quality of the bone that is available to support an implant decreases, the skill required to successfully insert the dental implant increases. A failed implant is costly and painful to remove. In addition, surgical removal may cause secondary tissue damage to an extent that additional dental implants may not be feasible.

Other methods are thus desirable.

### DETAILED DESCRIPTION

A localized, relatively pain-free method to prepare periodontal tissue for a dental implant is disclosed. In one embodiment, the method promotes localized generation of tissue at a dental implant site using at least one bone anabolic drug administered by microneedle array. The implant site may be monitored for tissue generation sufficient to support a dental implant at the site. In one embodiment, the method hastens healing following dental implant surgery. In one embodiment, the method enhances alveolar bone formation. In one embodiment, a kit contains at least one microneedle array and at least one bone anabolic drug.

Methods for controlling localized delivery of a bone anabolic drug, that is, a substance that promotes bone tissue formation, by a microneedle array to prepare and/or provide the drug to a dental implant site are disclosed. Methods for treatment subsequent to implantation, including microneedle array delivery of such drugs to the dental implant site to enhance osseointegration and healing, are also disclosed. Embodiments of the disclosed method are useful to promote periodontal tissue regeneration at a dental implant site.

As is known in the art, a tooth has a crown and a root. The root is seated in an alveolar bone, also referred to as the jawbone. As used herein, periodontal tissue or periodontium refers to tissues surrounding and supporting the tooth, such as the alveolar and supporting bone, cementum, periodontal ligaments, and gingiva. A buccal and a lingual portion of the alveolar bone are sheathed in the gingiva or gum. Disease or injury of any of these tissues may result in tooth loss, or tooth loss may be due to deliberate extraction.

One embodiment of the method uses a microneedle array to control delivery of one or more anabolic molecules, also referred to herein as bone anabolic drugs, or periodontal generating compounds, to a local area of the periodontium. No surgical procedures are used to prepare the periodontal tissues for the dental implant. In accordance with this embodiment, periodontal tissues are locally administered such drugs to rehabilitate atrophied tissue prior to surgically installing the dental implant. Pretreatment may improve the probability of a successful implant and long term implant stability.

In other embodiments, one or more additional microneedle array applications to the treated tissues continue following implantation. For example, an individual may lack sufficient periodontal tissue to successfully receive and retain the dental implant. However, in accordance with one embodiment, localized drug administration at the dental implant site regenerates the periodontal tissue to accept the dental implant. The method also improves the long-term viability of the dental implant.

In one embodiment, the microneedle array may deliver drug(s) at any buccal and/or lingual mucosa membrane accessible to a patient or practitioner. For example, the area may include tissues surrounding or in contact with the maxilla or mandible bones. Therefore, references to a particular location for controlled delivery by the microneedle array should not be interpreted as limiting any of the described embodiments to a particular tissue.

Microneedle arrays and their structure and capabilities are known in the art. They are available from, e.g. Debiotech S. A., Switzerland. An array typically has multiple needles, sometimes numbering in the thousands, per array. Each needle is on the order of a few microns wide and is usually less than 1000 microns long. There are many designs of microneedle arrays. In one example, microneedle arrays deliver drugs through the skin, and may carry the drug in or on the needle. As a result, delivery of the drug may begin as the needles penetrate the skin. In other examples, additional manipulation of the microneedle, e.g. operating a plunger, is required to inject the drug into the tissue. Mirconeedles are described in U.S. Pat. No. 6,945,952 and U.S. Published Patent Application Nos. 2005/0137531 and 2003/0208167, each of which is expressly incorporated by reference herein.

By controlling drug delivery with the microneedle array, a dose of a bone anabolic drug is locally administered and controllably retained at the desired periodontal tissue to receive, or which has received, a dental implant. The method avoids systemic exposure to the drug while generating sufficient drug concentration to impart the desired effects at the site. Additional doses of the drug may follow according to a treatment regimen, or on an ad hoc basis while the practitioner monitors the dental implant site to detect bone generation.

Once the dental implant site has sufficient bone to support the dental implant, the practitioner may surgically insert the dental implant according to procedures known in the art. Monitoring may be, e.g., by x-ray, visual inspection, or dental impressions.

The bone anabolic drug may be a protein in its native form, recombinant form, or in a form otherwise modified to produce the desired results when administered. In one embodiment, for example, the drug may be a member of the transforming growth factor β (TGF-β) superfamily, such as bone morphogenetic protein (BMP), e.g., BMP-2, BMP-4, BMP-7, BMP-9, or other BMPs that enhance alveolar bone growth. In another embodiment, the drug may alternatively be an angiogenesis promoting factor such as fibroblast growth factor 2 (FGF-2). The drug may be a statin, e.g., LIPITOR®, ZOCOR®, or CRESTOR®, to accelerate blood vessel growth and bone formation by one or more mechanisms. The drug may be parathyroid hormone (PTH) or one of it derivatives. Other proteins may include vitamin D, particularly vitamin D3 or a derivative thereof or prostaglandins, such as prostaglandin E and prostaglandin receptor-selective agonists including EP2 and EP4 agonists. Other anabolic drugs may be used as known to one skilled in the art.

In addition, drugs that target cell signalling pathways involved in the regulation of the osteoblastic lineage and function may also be administered. Among those pathways are the canonical Wnt/b-catenin pathway, sonic hedgehog, and the BMP pathway via SMAD1/5. Thus, in another embodiment, the bone anabolic drug may be a molecular entity that acts along those cell signaling pathways, such as Wnt-signaling, smad, beta-catenin, or sonic hedgehog. For example, proteasome inhibitors like epoxomicin, eponemycin, proteasome inhibitor-1 (PS1), MG132 (carbobenzylozy-L-leucyl-L-leucyl-L-leucinal), lactacystin, MG115 (carbobenzyloxy-L-leucyl-L-leucyl-L-norvalinal), bortezomib (VELCADE®, Millennium Pharmaceuticals, Inc.), and glycogen synthase kinase 3 (GSK3) inhibitors are known to cause bone anabolic responses in animals that mimic Wnt-signaling through an increase in intracellular b-catenin levels.

The described drugs may be used alone or in combination. The drug may include excipients, as well as other actives including, but not limited to, antibiotics, anesthetics, anti-inflammatories, etc. Thus, while the drugs rehabilitate and enhance bone growth, the other compounds may address ancillary problems such as ameliorating the underlying disease, or reducing pain. Therefore, for example, a practitioner may begin treatment by prescribing a microneedle array treatment where each microneedle array carries multiple drugs, such as antibiotics in combination with an angiogenic factor. When the practitioner is satisfied with the patient's progress, determined, for example, by periodic visual inspection or x-ray examination, the practitioner may continue treatment by transitioning the microneedle arrays to deliver a BMP.

Once the dental implant site is in a condition to successfully receive the dental implant, the practitioner surgically installs the dental implant. Following surgery, the practitioner may, once again, use microneedle arrays that carry a variety of drugs for infection prevention while promoting cementogenesis, osseogensis, and connective tissue formation. By following the patient's progress, the practitioner may non-systemically, easily, and rapidly alter treatment where necessary to improve the patient's healing time.

The dental implant site is prepared by local, controlled administration of drugs via a microneedle array according to embodiments of the method to successfully receive the dental implant. The controlled delivery of one or more bone anabolic drugs by a microneedle array is non-invasive, simple, convenient, and painless. Thus, the drug delivery with microneedle arrays may be administered by the patient under the direction of the practitioner, by the practitioner on an out-patient basis, or by a family member, caregiver, etc. The microneedle arrays may be preloaded under industrial conditions (e.g. an adhesive bandage) and the practitioner may then adjust dosing frequency and/or alter administered drugs following periodic evaluation. If the patient has an adverse reaction to the drug following microneedle array delivery, the patient or practitioner may discontinue usage immediately, thus halting an adverse consequence without having to wait for systemic drug clearance. Immediate discontinuance also occurs without surgery, which compares favorably with the need to surgically (i.e., invasively) remove the implant should the implant not have sufficient bone support. The practitioner may prepare the patient's periodontal tissue to receive the dental implant according to the patient's needs on a dose-to-dose basis. The treatment frequency and duration may be adjusted to ensure a high probability of a successful implant. The controlled administration of the drug may be once or twice a day, every other day, once per week, or bi-weekly depending on the type of drug and the patient's condition, as well as other factors. In one embodiment, the drug(s) and dosing frequency are selected to achieve a desired result.

Dental implants include any known in the art. By way of example and not limitation, the dental implant may be root form implants which are conical or tapered to mimic the natural root form. The dental implant may be subperiosteal or blade implants. In particular, the dental implant may be a TAPERED SCREW-VENT® implant (Zimmer Dental, Inc.). Other dental implants may have thread-like anchoring portions that ensure bony fixation, enabling load transfer to the jawbone. Some dental implants are available as single components with the implant and abutment formed as a unitary piece, while others are available as multipiece components with implant and abutment as separate pieces. Both single and multipiece are commercially available (e.g., Zimmer Dental, Inc.).

According to procedures known in the art, the dental implant is surgically inserted in the generated tissue. Once the dental implant is installed, the method may comprise subsequent treatments. Similar to controlled delivery of various drugs via the microneedle array prior to implantation, subsequent treatments may include the same or similar drug combinations, or different drugs alone or in combination. Subsequent treatments may occur over a finite period to accelerate healing and osseointegration of tissue into the implant. Subsequent treatments may also extend over many years to maintain or enhance tissue support of the dental implant or be used to treat existing implants that are in danger of imminent loss.

The aforementioned description and embodiments are not limiting. Therefore, various modifications to these embodiments may be made without departing from the spirit of the invention and the scope of the following claims.

What is claimed is:

1. A method comprising using a microneedle array to controllably administer a dose of a bone: anabolic drug localized at a dental implant site, thus controlling delivery of the bone anabolic drug at the dental implant site; and thereafter monitoring the dental implant site for periodontal tissue generation sufficient to support a dental implant.

2. The method of claim 1 further comprising thereafter implanting the dental implant in the dental implant site, the dental implant supported by the generated periodontal tissue.

3. The method of claim 1 wherein the bone anabolic drug enhances alveolar bone growth at the dental implant site.

4. The method of claim 1 wherein at least one additional dose is delivered prior to detecting tissue generation.

5. The method of claim 1 wherein at least one additional compound is delivered prior to detecting tissue generation.

6. The method of claim 1 wherein the bone anabolic drug is selected from the group consisting of bone morphogenetic proteins, fibroblast growth factor 2, statins, parathyroid hormone, and combinations thereof.

7. The method of claim 1 wherein the bone anabolic drug is selected from the group consisting of epoxomicin, eponemycin, bortezomib, proteasome inhibitor-1 (PS1), MG132 (carbobenzylozy-L-leucyl-L-leucyl-L-leucinal), lactacystin, MG115 (carbobenzyloxy-L-leucyl-L-leucyl-L-norvalinal), glycogen synthase kinase 3 (GSK3) inhibitors, and combinations thereof.

8. A method to enhance alveolar bone formation in gingival tissue, the method comprising
controlling administration of a bone anabolic drug dose provided by a microneedle array localized to gingival tissue into which a dental implant has been implanted, thus controlling the bone anabolic drug delivery at a dental implant site; and
detecting bone generation at the dental implant site thus enhancing alveolar bone anabolism in gingival tissue.

9. A method comprising controlling administration of a concentration of a drug sufficient to stimulate alveolar bone growth within about 3 to about 6 months, the drug selected from the group consisting of bone morphogenetic proteins, fibroblast growth factor 2, statins, parathyroid hormone, epoxomicin, eponemycin, bortezomib, proteasome inhibitor-1 (PS1), MG132 (carbobenzylozy-L-leucyl-L-leucyl-L-leucinal), lactacystin, MG115 (carbobenzyloxy-L-leucyl-L-leucyl-L-norvalinal), glycogen synthase kinase 3 (GSK3) inhibitors, and combinations thereof, the drug provided by a microneedle array localized at a dental implant site, thus controlling drug delivery at the dental implant site;
detecting bone generation at the dental implant site sufficient to support a dental implant; and
thereafter implanting the dental implant in the dental implant site, the dental implant supported by the generated bone.

10. The method of claim 9 wherein drug delivery is administered at a frequency of between about once per day to once per week.

11. The method of claim 9 performed subsequent to implanting the dental implant to accelerate fixation of the dental implant.

12. The method of claim 9 wherein drug delivery is patient controlled.

13. The method of claim 9 wherein drug delivery is practitioner controlled.

14. A kit comprising a microneedle array containing at least one anabolic drug; and instructions for using the microneedle array to penetrate a gingiva and release the drug locally, thus localizing preparation of the gingiva for a dental implant.
